(19) United States
(12) Patent Application Publication
(10) Pub. No.: US 2008/0287604 A1
(43) Pub. Date: Nov. 20, 2008

(54) Hydrogel Including Modified Cyclodextrin Crosslinked With Polyurethane Prepolymer

(75) Inventor: Anne Marie Paule Wibaux, Antwerpen (BE)

Correspondence Address: AVERY DENNISON CORPORATION;Patent Group, Law Department - 3 South, P.O. BOX 7090, PASADENA, CA, 91109-7090, US

(73) Assignee: Avery Dennison Corporation, Pasadena, CA (US)

(21) Appl. No.: 12/066,074

(22) PCT Filed: Sep. 8, 2006
(86) PCT No.: PCT/US06/34929

§ 371 Date: Mar. 6, 2008

Related U.S. Application Data
(60) Provisional application No. 60/715,436, filed on Sep. 9, 2005.

(51) Int. Cl. C08G 18/64; C08G 18/12; C08B 37/00

(52) U.S. Cl. 525/54.2; 527/301

(57) ABSTRACT

A hydrogel composition comprising a modified cyclodextrin crosslinked with a polyurethane prepolymer. In one embodiment, the hydrogel includes a ratio of the modified cyclodextrin to the polyurethane prepolymer selected to result in formation of the hydrogel. The hydrogel composition may be used in a personal care product. A process for preparing a hydrogel, including providing a modified cyclodextrin; providing a polyurethane prepolymer; combining the modified cyclodextrin with the polyurethane prepolymer; and allowing the polyurethane prepolymer to react with and crosslink the cyclodextrin to form the hydrogel. A process for preparing a hydrogel-containing article such as a personal care product, including preparing the hydrogel and applying it or the components thereof to a suitable substrate.

### TECHNICAL FIELD

The present invention relates to hydrogel compositions including a modified a modified cyclodextrin crosslinked with a polyurethane prepolymer, and to articles containing such hydrogel compositions.

### RELATED ART

Cyclodextrins are cyclic molecules including, most commonly, six, seven or eight alpha-D-(+)-glucopyranose rings bonded together by 1,4 linkages. The common cyclodextrins, having six, seven or eight rings are referred to as alpha-(α-), beta- (β-) and gamma- (γ-) cyclodextrin, respectively. These cyclodextrins may be conveniently referred to in abbreviated form as α-CD, β-CD and γ-CD, respectively, and cyclodextrin generally may be referred to as CD. Larger cyclodextrins have been isolated, but are not commonly used. Cyclodextrins are non-reducing alpha-1,4-maltooligosaccharides. Cyclodextrins are formed enzymatically from starch by the action of cyclodextrin glycosyltransferase (EC.3.2.1.19) produced from certain microorganisms. Cyclodextrins are known to be useful for their ability to reversibly form inclusion complexes, sometimes referred to as clathrates, with many types of compounds. This ability results from the molecular shape, which has been likened to a doughnut or a truncated cone with a cylindrically-shaped cavity formed in the center of the doughnut or truncated cone. The outer surface of cyclodextrin is generally hydrophilic, while the interior cavity is generally hydrophobic. The hydrophilic outer portion allows free cyclodextrins to be water soluble. The hydrophobic interior cavity allows the cyclodextrins to absorb or from inclusion complexes with, e.g., organic compounds of appropriate size. In α-CD, the interior cavity has a diameter of about 5 angstroms; the interior cavity of β-CD has a diameter of about 7 angstroms, and the interior cavity of γ-CD has a diameter of about 9 angstroms. The interior cavities of all three cyclodextrins have a depth of about 7 angstroms.

Hydrogels are aqueous compositions capable of maintaining a gel-like state, in which a disperse phase is combined with water to produce a semisolid material. A hydrogel may be considered as a form of colloid, in which a disperse phase is combined with a dispersion medium; in the hydrogel, water is the dispersion medium.

A hydrogel, as used herein, is a polymeric material which exhibits the ability to swell in water or to absorb at least 100% of its weight in water to which it is exposed and to retain the water within its structure without dissolving or losing its hydrogel character, and to retain its structural integrity such that the hydrogel material does not, e.g., crumble, flow, detach from the support member, or otherwise deteriorate in such a way as to render it unsuitable in its intended use.

In the prior art, various polymers have been used to form hydrogels. Some materials referred to as hydrogels have the capability to absorb moisture, but doing so eventually causes some hydrogels to lose their semisolid form and become more liquid, due to the additional water. Such materials are not within the definition of hydrogel as used herein.

Hydrogels may be used in wound treatment, drug delivery and other medical applications.

A need remains for hydrogels capable of absorbing relatively large quantities of water while maintaining the semisolid state, without dissolving and without losing the hydrogel character. A need remains for hydrogels capable of absorbing water and swelling to two or more times the original volume of the hydrogel. A need remains for hydrogels capable of absorbing water and gaining weight to two or more times the original volume of the hydrogel. A need remains for hydrogels capable of absorbing odors and/or capable of holding and delivering organic agents such as pharmaceuticals, perfumes, and other materials, and capable of maintaining their hydrogel character when wetted. A need remains for hydrogels exhibiting combinations of these features, as well as for hydrogels exhibiting these and combinations with additional features, such as, for example, hydrogels providing tack and formulations which have an easily controllable crosslinking reaction in the formation of the hydrogel, while retaining the capability of absorbing relatively large quantities of water while maintaining the semisolid state, without dissolving and without losing the hydrogel character.

### SUMMARY

In one embodiment, the present invention relates to a hydrogel composition including a modified cyclodextrin crosslinked with a polyurethane prepolymer. In one embodiment, the hydrogel includes a ratio of the modified cyclodextrin to the polyurethane prepolymer selected to result in formation of the hydrogel.

In another embodiment, the present invention relates to a process for preparing a hydrogel, including:

providing a modified cyclodextrin;

providing a polyurethane prepolymer; and

combining the modified cyclodextrin with the polyurethane prepolymer; and

allowing the polyurethane prepolymer to react with and crosslink the cyclodextrin to form the hydrogel.

In another embodiment, the present invention relates to a process for preparing a hydrogel-containing personal care product, including:

providing a cyclodextrin;

providing a polyurethane prepolymer;

combining the cyclodextrin with the polyurethane prepolymer and allowing the polyurethane prepolymer to react with and crosslink the cyclodextrin to form a hydrogel; and

applying the combined cyclodextrin and polyurethane prepolymer to a substrate to form the hydrogel-containing personal care product.

In another embodiment, the present invention relates to a personal care product including a hydrogel composition including a modified cyclodextrin crosslinked with a polyurethane prepolymer, in which the hydrogel is applied to a substrate.

In one embodiment, the hydrogel of the present invention includes a modified cyclodextrin with improved crosslinking capability, which can provide odor absorption in addition to providing a stabilizing effect to the hydrogel by virtue of the cyclodextrin having been crosslinked into the hydrogel structure.

In some embodiments, the hydrogel composition further comprises natural or un-modified cyclodextrin, which may or may not be crosslinked or bonded to the crosslinked structure.

The present invention, in its various embodiments, thus addresses the needs described above. That is, in one embodiment, the hydrogel is capable of absorbing relatively large quantities of water while maintaining the semisolid state, without dissolving and without losing its hydrogel character. In another embodiment, the hydrogel is capable of absorbing water and swelling to two or more times its original volume. In another embodiment, the hydrogel is capable of absorbing water and increasing its weight to two or more times its original weight. In another embodiment, the hydrogel is capable of absorbing odors and/or delivering various agents. In another embodiment, the hydrogel exhibits various combinations of these features. In other embodiments, the hydrogel exhibits combinations of various of the foregoing features and combinations of various of the foregoing features and additional features, such as, for example, combinations providing tack and, in some formulations, having an easily controllable crosslinking reaction in formation of the hydrogel, while retaining the capability of absorbing relatively large quantities of water while maintaining the semisolid state, without dissolving and without losing the hydrogel character.

### DETAILED DESCRIPTION

In one embodiment, the present invention relates to a hydrogel composition comprising a modified cyclodextrin crosslinked with a polyurethane prepolymer. In one embodiment, a ratio of the modified cyclodextrin to the polyurethane prepolymer is selected to result in formation of the hydrogel. That is, while it is possible to combine a cyclodextrin with a polyurethane prepolymer in a wide range of ratios, in the present invention, the ratio is selected, and the reaction conditions are selected, such that a hydrogel, as defined herein, is formed from the cross-linking reaction between the modified cyclodextrin and the polyurethane prepolymer.

### Modified Cyclodextrin

Native or natural unmodified cyclodextrin includes three hydroxyl groups on each glucopyranose ring. Each of the hydroxyl groups is an isocyanate-reactive group. However, the isocyanate reactivity of theses hydroxyl groups is restricted or reduced to some degree due to steric effects of the remainder of the cyclodextrin molecule compared to hydroxyl groups in molecules in which the hydroxyl group is more easily accessible. Thus, in order to increase the reactivity of the cyclodextrin to the reactive isocyanate groups of the polyurethane prepolymer, it has been found useful to modify the cyclodextrin by addition of groups providing better steric access for reaction with the reactive isocyanate groups with which it is desired to react in forming the hydrogel composition of the present invention.

In one embodiment, the modified cyclodextrin is modified by being bonded to a moiety comprising at least one isocyanate-reactive group. In many isocyanate-reactive groups, the reactivity results from the presence of an active hydrogen. Examples of suitable moieties comprising isocyanate-reactive groups include a hydroxyalkyl group, an aminoalkyl group, a carboxyl group, a sulfhydryl group, an epoxy group, or a combination of any two or more thereof. Of these, all but the epoxy include an active hydrogen. In one embodiment, the term “active hydrogen” refers to a moiety containing a hydrogen atom which, because of its position in the molecule, displays significant activity according to the Zerewitnoff test, described by Wohler in JACS, Vol. 49, p. 3181 (1927). Illustrative active hydrogen moieties include —COOH, —OH, —NH₂, NH—, CONH₂, —CONH— and —SH.

As described above, cyclodextrins include six, seven or eight, and possibly more, glucopyranose rings. Each glucopyranose ring includes three hydroxyl groups, two secondary hydroxyl groups attached to carbon atoms on the ring itself and one primary hydroxyl group attached to the methylene carbon attached to the ring. A schematic diagram or drawing of a cyclodextrin molecule is shown below:

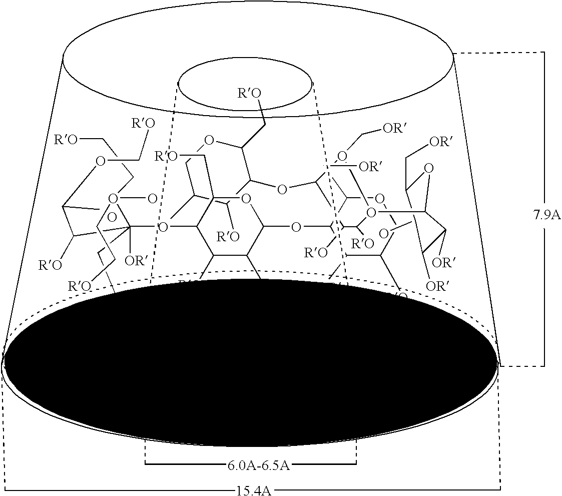

In this drawing, the hydroxyl groups on the lower side are the secondary hydroxyls, and the hydroxyl groups on the upper side are the primary hydroxyls. As noted above, there are three hydroxyl groups on each glucopyranose ring, each of which is capable of reacting with an appropriate group to form either a crosslinking bond or a derivatizing or modifying bond. Each of the three hydroxyl groups on each of the glucopyranose rings of the cyclodextrin exhibits slightly different reactivity. As suggested by the drawing above, the hydroxyl groups are accessible but may be somewhat sterically hindered, thus exhibiting lower reactivity than would hydroxyl groups on, e.g., a single glucopyranose ring.

In order to enhance the availability of reactive sites, and thus to increase the isocyanate reactivity of the cyclodextrin as a whole, the cyclodextrin may be modified or derivatized. In this regard, it is noted that in the drawing above, rather than —OH groups, —OR groups are shown, suggesting that R may be other than hydrogen. Thus, in the cyclodextrin shown in the drawing, the R groups can be hydrogen or any one of a number of substituents, such as hydroxypropyl, amino, amido, and carboxyl, just to name a few. Cyclodextrin may be modified with a wide variety of groups. In many such embodiments, the derivative is formed through a bond to the oxygen atom of one or more of the three available hydroxyl groups on the glucopyranose rings of the cyclodextrin. In one embodiment, the substituent includes the reactive moiety, i.e., the —OH, —SH, —NH₂, or other group, on the terminal carbon atom, that is on the carbon atom most distant from the cyclodextrin molecule. However, the reactive moiety may be on any carbon atom in the modifying group.

In one embodiment, the modified cyclodextrin of the present invention is modified by derivitization by a hydroxyalkyl group (—ROH), an aminoalkyl group (—RNH₂ or —RNHR′), an alkyl-carboxyl group (—RCOOH), an alkylsulfhydryl group (—RSH), an epoxy group, or a combination of any two or more thereof.

In one embodiment, the modified cyclodextrin includes a C₁-C₆ mono-, di- or higher hydroxyalkyl group, such as a hydroxymethyl, hydroxyethyl, 2- or 3-hydroxy-n-propyl, 2- or 3-hydroxyisopropyl, alcohols of higher alkyl groups (C₇ or higher, up to at least C₁₂), and diols, triols and higher polyols of such alkyl groups. The hydroxyl group(s) may be on any carbon atom of the alkyl group. In one embodiment, in the above noted —ROH, R may range from C₁ to about C₆, and in another embodiment, R may range from C₁ up to at least C₁₂. In one embodiment, the modified cyclodextrin is 2-hydroxypropyl cyclodextrin, and in one embodiment, the modified cyclodextrin is 2-hydroxypropyl β-cyclodextrin, a particularly well known and well-studied modified cyclodextrin. In another embodiment, the modified cyclodextrin is 3-hydroxypropyl cyclodextrin. In the 3-hydroxypropyl cyclodextrin, the hydroxyl group should be more sterically accessible for reaction by, e.g., the reactive isocyanate of a polyurethane prepolymer.

In one embodiment, the modified cyclodextrin includes an alkyl-thiol or alkyl-sulfhydryl group, that is an alkyl group containing an —SH substituent. The hydrogen on the —SH group is an active hydrogen. Suitable alkylthiols are any corresponding to the above-identified mono- or poly-hydroxyalkyl groups. The thiol group(s) may be on any carbon atom of the alkyl group. In one embodiment, in the above noted —RSH, R may range from C₁ to about C₆, and in another embodiment, R may range from C₁ up to at least C₁₂.

In one embodiment, the modified cyclodextrin includes an aminoalkyl group, that is, an alkyl group containing an amine moiety. In one embodiment, the amine moiety is either a primary or secondary amine, both of which have an active hydrogen. Suitable aminoalkyl groups include, for example, alkyl groups having one or more primary or secondary amine groups, and from 1 to about 12 carbon atoms, in one embodiment from 1 to about 8 carbon atoms, and in another embodiment from 1 to about 6 carbon atoms, and in still another embodiment, 1, 2 or 3 carbon atoms. The amino group(s) may be on any carbon atom of the alkyl group. In one embodiment, in the above noted —RNH₂ or —RNHR′, R and R′ independently may range from C₁ to about C₆, and in another embodiment, R may range from C₁ up to at least C₁₂. In addition, as noted above, in one embodiment, the modified cyclodextrin may include an amide, either primary or secondary, corresponding to any of the foregoing amines and the following carboxylic acids. In one embodiment, the reaction of an amine with a given polyurethane prepolymer is much faster than the reaction of a hydroxyl group with the given polyurethane prepolymer.

In one embodiment, the modified cyclodextrin includes a carboxyl group, i.e., a —RCOOH group, where R may be a bond to the oxygen atom of the cyclodextrin, or a C₁ to about a C₁₂ alkyl group. Thus, for example, the cyclodextrin may be substituted with a formyl, acetyl, propionyl, or higher alkyl-carboxyl group. The carboxyl group(s) may be on any carbon atom of the alkyl group. In one embodiment, in the above noted —RCOOH, R may range from C₁ to about C₆, and in another embodiment, R may range from C₁ up to at least C₁₂

In one embodiment, the modified cyclodextrin includes an epoxy group, i.e., a group having a general formula:

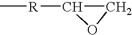

where R may be a bond to the oxygen atom of the cyclodextrin, or a C₁ to about a C₁₂ alkyl group. The epoxy group(s) may be on any carbon atom of the alkyl group.

In one embodiment, in any of the above substituted cyclodextrins, R may be a cycloalkyl group, an aryl group, an alkylaryl group, an arylalkyl group, an ether-containing group, or other known group capable of attachment to the cyclodextrin molecule via one of the hydroxyl groups, alternative to the alkyl groups described above, and containing at least one isocyanate-reactive group in the R group. In one embodiment, any of these “linking” groups may be used, with the proviso that the cyclodextrin is substituted with a group including a reactive moiety, such as the active hydrogen mentioned above, that functions to increase the ability of the cyclodextrin molecule to be crosslinked in forming the hydrogel of the present invention.

Suitable methods are known in the art for forming the foregoing modified cyclodextrins. Suitable methods for preparation of a wide variety of suitably modified cyclodextrins are disclosed in Croft et al., “Synthesis of Chemically Modified Cyclodextrins”, Tetrahedron, Vol. 39, No. 9, pp. 1417-1474, 1983, in. In addition, modified cyclodextrins are commercially available commercially, for example, from CyDex, Inc., Lenexa, Kans., from CycloLab Ltd., Budapest, Hungary, and from Cyclodextrin Technologies Development, Inc., High Springs, Fla.

### Polyurethane Prepolymer

In one embodiment, the polyurethane prepolymer comprises a reactive isocyanate moiety. In one embodiment, the reactive isocyanate moiety comprises an aliphatic, cycloaliphatic, arylaliphatic, heterocyclic or aromatic polyisocyanate or a mixture thereof.

In one embodiment, the polyurethane prepolymer has an average isocyanate functionality of about 2 or greater. In another embodiment, the polyurethane prepolymer has an average isocyanate functionality of about 2.2 or greater, and in another embodiment, the polyurethane prepolymer has an average isocyanate functionality of about 2.5 or greater, and in yet another embodiment, the polyurethane prepolymer has an average isocyanate functionality of about 3 or greater, while in still another embodiment, the polyurethane prepolymer has an average isocyanate functionality of about 4 or greater.

Examples of such polyisocyanates include ethylene diisocyanate, 1,4-tetramethylene diisocyanate, 1,6-hexamethylene diisocyanate, 1,12-dodecane diisocyanate, cyclohexane-1,3- and 1,4-diisocyanate and mixtures of these isomers; 2,4- and 2,6-toluene diisocyanate and mixtures of these isomers, 1,3- and/or 1,4-phenylene diisocyanate, 2,5′- and/or 4,4′-diphenyl methane diisocyanate, and mixtures of these isomers, diphenyl methane-2,4′- and/or 4,4′-diisocyanate, naphthylene-1,5-diisocyanate, triphenyl methane-4,4′,4″triisocyanate, polyphenyl polymethylene polyisocyanates and similar known polyisocyanates. In one embodiment, the polyisocyanate used as the polyurethane prepolymer is one of the toluene diisocyanates.

In one embodiment, the polyurethane prepolymer comprises a polyisocyanate such as toluene-2,4-diisocyanate, toluene-2,6-diisocyanate, a mixture of toluene 2,4-diisocyanate and toluene-2,6-diisocyanate, m-phenyl-diisocyanate, 3,3′-diphenyl-4,4′-biphenylene diisocyanate; 4,4′-biphenylene diisocyanate; 4,4′-diphenylmethane diisocyanate; 3,3′-dichloro-4,4′-biphenylene diisocyanate; cumene-2,4-diisocyanate; 1,5-napthalene diisocyanate; p-phenylene diisocyanate; 4-methoxy-1,3-phenylene diisocyanate; 4-chloro-1,3-phenylene diisocyanate; 4-bromo-1,3-phenylene diisocyanate; 4-ethoxy-1,3-phenylene diisocyanate; 2,4-dimethyl-1,3-phenylene diisocyanate; 5,6-dimethyl-1,3-phenylene diisocyanate; 2,4-diisocyanatodiphenylether; 4,4′-diisocyanatodiphenylether benzidine diisocyanate; 4,6-dimethyl-1,3-phenylene diisocyanate; 9,10-anthracene diisocyanate; 4,4′-diisocyanatodibenzyl; 3,3′-dimethyl-4,4′-diisocyanatodiphenylmethane; 2,6-dimethyl-4,4′-diisocyanatodiphenyl; 2,4-diisocyanatostilbene; 3,3′-dimethoxy-4,4′-diisocyanatodiphenyl; 1,4-anthracene diisocyanate; 2,5-fluorene diisocyanate; 1,8-naphthalene diisocyanate; 2,6-diisocyanatobenzfuran; 2,4,6-toluene triisocyanate; p,p′,p″-triphenylmethane triisocyanate; polymeric 4,4′-diphenylmethane diisocyanate; isophorone diisocyanate, hexamethylene diisocyanate, trans-1-4 cyclohexyl diisocyanate, 2,4- and 2,6-hexahydrotoluene diisocyanate, 4,4′-, 2,2′-, or 2,4′-dicyclohexylmethane diisocyanate, or 1,3,5-tricyanatocyclohexane, or mixtures or combinations of any two or more of the foregoing. In one embodiment, the polyisocyanate is isophorone diisocyanate.

In one embodiment, the polyurethane prepolymer may be a partially polymerized polyurethane polymer having unreacted isocyanate groups suitable for crosslinking the modified cyclodextrins. Thus, for example, in one embodiment, the polyurethane prepolymer may be a reaction product of a polyether polyol with an excess of polyisocyanate, in which a polyurethane has been formed, but in which reactive isocyanate groups remain as end groups on the polymer chains. In one embodiment, the polyether polyol is a lower alkyl polyether polyol, for example, a methyl, ethyl, propyl or butyl polyether polyol, or mixtures and combinations of two or more thereof. The alkyl groups may be branched or un-branched.

In one embodiment, the partially polymerized polyurethane prepolymer has a weight average molecular weight in the range from about 500 to about 30,000 or higher. In one embodiment, the partially polymerized polyurethane prepolymer has a weight average molecular weight in the range from about 500 to about 10,000. In one embodiment, the partially polymerized polyurethane prepolymer has a weight average molecular weight in the range from about 1000 to about 5,000. In one embodiment, on average, each molecule of the partially polymerized polyurethane prepolymer has an isocyanate functionality of about two or greater. In one embodiment, on average, each molecule of the partially polymerized polyurethane prepolymer has a weight average molecular weight in the range from about 500 to about 10,000, and has an isocyanate functionality of about 2 or greater.

Suitable polyurethane prepolymers are commercially available, for example, from The Dow Chemical Co., Midland, Mich., under the trademark HYPOL®, and from Cytec Industries Inc. under the trademark CONATHANE®, and from Air Products and Chemicals, Inc., Allentown, Pa. under the trademarks AIRTHANE® and VERSATHANE®.

Crosslinking Cyclodextrin with Polyurethane Prepolymers

In one embodiment, the modified cyclodextrin crosslinked by a polyurethane prepolymer comprises a reaction product of a reactive isocyanate moiety reacted with at least one isocyanate-reactive group on the cyclodextrin. In one embodiment, when the modified cyclodextrin is crosslinked by a polyurethane prepolymer, a reactive isocyanate moiety on the polyurethane prepolymer reacts with at least one isocyanate-reactive group on the cyclodextrin. In one embodiment, at least two isocyanate-reactive groups on the modified cyclodextrin react with reactive isocyanate moieties. The at least one isocyanate-reactive group may be a primary hydroxyl group of the cyclodextrin, a secondary hydroxyl group of the cyclodextrin, an active hydrogen or another reactive group on a modifying group attached to the cyclodextrin, or a combination of any two or more thereof. In one embodiment, at least a portion of the isocyanate-reactive group is the active hydrogen on a modifying group attached to the cyclodextrin. In general, the cyclodextrin is modified in order to improve the availability of the isocyanate-reactive group for reaction with a reactive isocyanate moiety on the polyurethane prepolymer.

As will be recognized, as a result of the crosslinking reaction, it is possible that some of the modified cyclodextrin may not be crosslinked. That is, some portion of the modified cyclodextrin may be completely unreacted or may be singly reacted with the polyurethane prepolymer.

In one embodiment, the hydrogel composition further includes non-modified cyclodextrin. In one embodiment, the hydrogel composition may further include non-crosslinked modified and/or non-crosslinked non-modified cyclodextrin. In one embodiment, the non-crosslinked modified cyclodextrin may include free modified and/or non-modified cyclodextrin, modified and/or non-modified cyclodextrin singly bonded to the polyurethane prepolymer or a mixture of any two or more thereof. Thus, modified cyclodextrin and/or non-modified cyclodextrin may be added to the hydrogel after the crosslinking, or may remain unreacted after the crosslinking. In one embodiment, the amount of unreacted modified cyclodextrin is determined by the ratio of the quantity of polyurethane prepolymer, e.g., the reactive polyisocyanate, to the quantity of active-hydrogen or isocyanate-reactive moieties present in the crosslinking reaction mixture. Additional details on further ingredients alternatively present in the crosslinking reaction mixture are provided below.

In one embodiment, the hydrogel composition further includes non-modified cyclodextrin crosslinked with the polyurethane prepolymer. Thus, in one embodiment, non-modified cyclodextrin may be added to the crosslinking reaction mixture, in addition to the modified cyclodextrin in the reaction mixture.

In one embodiment, the hydrogel composition of the present invention is capable of swelling upon absorption of water without losing its hydrogel form, that is, without dissolving or becoming liquified, by increasing its volume to about 100% greater than original, that is, to about twice its original volume. In another embodiment, the hydrogel composition of the present invention is capable of swelling upon absorption of water without losing its hydrogel form, that is, without dissolving or becoming liquified, by increasing its volume to about 200% greater than original. In another embodiment, the hydrogel composition of the present invention is capable of swelling upon absorption of water without losing its hydrogel form, that is, without dissolving or becoming liquified, by increasing its volume to about 300% greater than original. In another embodiment, the hydrogel composition of the present invention is capable of swelling upon absorption of water without losing its hydrogel form, that is, without dissolving or becoming liquified, by increasing its volume to about 400% greater than original. For example, in one embodiment, a hydrogel having an initial size, defined as zero percent swelling, upon exposure to moisture for a period of 18 hours, exhibits 195% swelling relative to its original volume, i.e., a swelling of about 200% greater than original, that is, about twice its original volume. This swelling capability is unexpected and surprising, since known hydrogels, while capable of some water absorption and swelling, are not believed to be capable of swelling to such a degree.

Similarly, in one embodiment, the hydrogel composition of the present invention is capable of increasing its own weight upon absorption of water without losing its hydrogel form, that is, without dissolving or becoming liquified, by increasing its initial weight to about 100% greater than its original weight. In another embodiment, the hydrogel composition of the present invention is capable of increasing its own weight upon absorption of water without losing its hydrogel form, that is, without dissolving or becoming liquified, by increasing its initial weight to about 200% greater than its original weight. In another embodiment, the hydrogel composition of the present invention is capable of increasing its own weight upon absorption of water without losing its hydrogel form, that is, without dissolving or becoming liquified, by increasing its initial weight to about 300% greater than its original weight. For example, in one embodiment, a hydrogel having an initial weight of about 2.0 grams, upon exposure to moisture for a period of 18 hours, exhibits a weight increase to about 6.5 grams, i.e., a weight increase of about 350% greater than it original weight. This water absorption/weight increase capability is unexpected and surprising, since known hydrogels, while capable of some water absorption and weight increase, are not believed to be capable of a weight increase to such a degree.

### Additional Components

In one embodiment, in preparing the hydrogel composition, the ingredients combined for the crosslinking further include an alkylene glycol, a polyalkylene glycol, glycerol or a combination of any two or more thereof. In one embodiment, the addition of these materials provides a greater adhesiveness to the hydrogel. Thus, in one embodiment, a portion of the alkylene glycol, the polyalkylene glycol, the glycerol or a combination of any two or more thereof is chemically bonded to the polyurethane prepolymer.

In one embodiment, at least a portion of the modified cyclodextrin is complexed with a suitably selected molecule. As is well known in the art, cyclodextrins are capable of complexing a wide variety of organic molecules, including pharmaceuticals, perfumes, fragrances, etc., e.g., by partially or completely holding molecules of the complexed material within the cyclodextrin cavity. Thus, the hydrogel composition of the present invention may be used in delivery of any suitable such material.

In one embodiment, the foregoing hydrogel may be used in an article such as a personal care product. Exemplary personal care products include, without limitation, one or more of a bandage, a wound dressing, a wipe, a diaper, a diaper pant, a training pant, an absorbent underpant, a protective swimming undergarment, an incontinence garment, a panty shield or liner, a feminine hygiene product or a perspiration shield. Other suitable articles and personal care products also may include the hydrogel composition of the present invention.

### Process for Preparing the Hydrogel

In one embodiment, the present invention relates to a process for preparing a hydrogel, including steps of:

providing a modified cyclodextrin;

providing a polyurethane prepolymer; and

combining the modified cyclodextrin with the polyurethane prepolymer; and

allowing the polyurethane prepolymer to react with and crosslink the cyclodextrin to form the hydrogel. In one embodiment, as noted above, quantities of the modified cyclodextrin and the polyurethane prepolymer are selected to result in formation of the hydrogel. That is, the ratio of the ingredients is selected to produce a desired hydrogel that is stable, swellable and exhibits the desired properties as described further herein.

In one embodiment, the modified cyclodextrin used in this method may be any of the modified cyclodextrins disclosed above. In one embodiment, the polyurethane prepolymer used in this method may be any of the polyurethane prepolymers disclosed above.

In one embodiment, the step of combining the modified cyclodextrin with the polyurethane prepolymer may be carried out at room temperature. In another embodiment, the step of combining may be carried out at an elevated temperature, in order to accelerate the reaction.

In carrying out the combination and allowing the polyurethane prepolymer to react with and crosslink the modified cyclodextrin to form the hydrogel, the reactive isocyanate groups preferentially react with the more easily accessible isocyanate-reactive moieties. Thus, for example, as noted above, the hydroxyl group on the hydroxypropyl group of a cyclodextrin modified by 2- or 3-hydroxypropyl should be more accessible and thereby more reactive than would be the hydroxyl groups on the cyclodextrin molecule itself. Similarly, it would be expected that the primary hydroxyl group on the 6-position of the cyclodextrin molecule would be more reactive to a reactive isocyanate group than would be the secondary hydroxyl groups at the 2- and/or 3-position of the cyclodextrin molecule.

It will be recognized by those in the art that a very large number of possible isomers of modified cyclodextrins are possible, and that a very large number of possible isomers for the crosslinked modified or non-modified cyclodextrin are possible. Since there are 6, 7 or 8 glucopyranose rings in the usual α-, β-, and γ-cyclodextrin molecules (respectively) and each glucopyranose ring includes three hydroxyl groups, any one or more of which may be modified and/or reacted with the reactive isocyanate group, a huge number of isomers are possible.

In one embodiment, the crosslinking reaction between the modified cyclodextrin and the polyurethane prepolymer may be carried out as follows. The modified cyclodextrin is dissolved in water at a concentration ranging from 0.1 wt % to saturation, depending on the objective. The solution of modified cyclodextrin is mixed with a polyurethane prepolymer. The mixed solution is coated onto a substrate such as a release liner or a polymeric backing and is crosslinked. The ratio of modified cyclodextrin to polyurethane prepolymer is selected to obtain the desired hydrogel.

In another embodiment, either the solution of modified cyclodextrin (with or without additional ingredients in the solution) or the polyurethane prepolymer may be applied to the substrate first, followed by the other of the modified cyclodextrin or polyurethane prepolymer, and thereafter the two components are allowed to react to form the cross-linked hydrogel composition. In this embodiment, the individual components may be applied independently by any suitable means, including spraying, roll coating, knife coating, doctor blade coating, etc. In one such embodiment, both components are applied by spraying onto the substrate.

In one embodiment, the ratio of modified cyclodextrin to polyurethane prepolymer may range from about 1:10 to about 10:1. In one embodiment, the ratio of modified cyclodextrin to polyurethane prepolymer may range from about 1:5 to about 5:1. In one embodiment, the ratio of modified cyclodextrin to polyurethane prepolymer may range from about 1:3 to about 3:1. In one embodiment, the ratio of modified cyclodextrin to polyurethane prepolymer is about 1:2. That is, when the ratio of modified cyclodextrin to polyurethane prepolymer is about 1:2, on average, each molecule of modified cyclodextrin can potentially react with two molecules of polyurethane prepolymer in the crosslinking reaction. In one such embodiment, the two molecules of polyurethane prepolymer in the crosslinking reaction are two different molecules of polyurethane prepolymer. Of course, with cyclodextrins containing from six to eight glucopyranose rings, each having as many as three hydroxyl groups available for reaction, any one molecule of modified cyclodextrin may be cross-linked to many more than two polyurethane prepolymer molecules. In addition, in an embodiment in which the modifying group of the modified cyclodextrin includes a plurality of hydroxyl or other isocyanate-reactive groups, the potential number of crosslinking sites becomes even greater.

In one embodiment, the process of the present invention further includes providing a polyol, e.g., an alkylene glycol, a polyalkylene glycol, glycerol or a combination of any two or more thereof and combining the alkylene glycol, the polyalkylene glycol, the glycerol or the combination of any two or more thereof with the modified cyclodextrin and the polyurethane prepolymer in the combining step or, in an alternative embodiment, premixing the alkylene glycol, the polyalkylene glycol, the glycerol or the combination of any two or more thereof with the modified cyclodextrin prior to the combining step. That is, in one embodiment, the foregoing materials may be added to the reaction mixture and will become part of the hydrogel composition, including in at least some embodiments, in which the alkylene glycol, polyalkylene glycol and/or glycerin may be crosslinked with or bonded to other components of the hydrogel, including the modified cyclodextrin and any free cyclodextrin which may also be present, by the polyurethane prepolymer. In one embodiment, addition of the alkylene glycol, the polyalkylene glycol, the glycerol or the combination of any two or more thereof with the modified cyclodextrin results in the formation of a hydrogel having improved adhesive properties, when the mixture is cross-linked by the polyurethane prepolymer.

in one embodiment, the polyol includes polyalkylene polyols or polyols comprising ethylene-oxide-derived monomeric units. In one embodiment, the polyol is water soluble. in one embodiment, the polyol has a weight average molecular weight in the range from about 200 to about 30,000. As noted above, in one embodiment, the weight average molecular weight of the polyurethane prepolymer may range from about 500 to about 30,000 or higher, and in another, from about 500 to about 10,000.

In one embodiment, the process of the present invention further includes combining a non-modified cyclodextrin with the modified cyclodextrin and the polyurethane prepolymer in the combining or premixing the non-modified cyclodextrin with the modified cyclodextrin prior to the step of combining. Thus, in this embodiment, the hydrogel will further include non-modified cyclodextrin as part of the hydrogel. In one embodiment, the non-modified cyclodextrin is crosslinked with the polyurethane prepolymer.

In one embodiment, the hydrogel further comprises non-crosslinked modified and/or non-crosslinked non-modified cyclodextrin. In this embodiment, some of the cyclodextrin, whether modified or non-modified, is either present as free cyclodextrin (modified or not modified) or present as modified or non-modified cyclodextrin which is singly-bonded to the polyurethane prepolymer. Thus, the modified or non-modified cyclodextrin that is singly bonded is chemically attached to the hydrogel, while any modified or non-modified cyclodextrin that is not bonded may form a part of the hydrogel, but is not chemically bonded and is thus subject to dissolution in water absorbed by the hydrogel.

Thus, in one embodiment, the hydrogel further comprises non-crosslinked modified cyclodextrin, free modified and/or non-modified cyclodextrin, modified and/or non-modified cyclodextrin singly bonded to the polyurethane prepolymer or a mixture of any two or more thereof.

In one embodiment, at least a portion of the modified cyclodextrin is complexed. The cyclodextrin may be provided in a complexed form, or a compound or material to be complexed may be added to the crosslinking reaction mixture (if it is not subject to reaction with the polyurethane prepolymer) or may be added to the hydrogel formed by the crosslinking reaction subsequent to completion of the crosslinking reaction.

### EXAMPLES

Selected embodiments of the hydrogel composition in accordance with the present invention are presented. These examples are provided to illustrate the invention and are not intended to limit the scope of the invention which is limited only by the scope of the claims appended hereto.

### Preparation of Solution A

Into 50 g of demineralized water, a 50 g sample of hydroxypropyl-β-cyclodextrin is dissolved. This is Solution A as used in the following Examples A-G shown in Table 1.

### Examples A-G

In the following Examples A-G, the above prepared Solution A is used in the indicated amounts, and the polyurethane prepolymer used is partially polymerized product of the reaction of a mixture of 2,4-toluene diisocyanate and 2,6-toluene diisocyanate with a polyethylene oxide and polypropylene oxide, in which the polyurethane prepolymer has terminal isocyanate groups. The TDI prepolymer used in the Examples shown in Table 1 is sold by Dow under the trade name HYPOL® 2060.

As shown in the table, in some of the Examples, additional ingredients, propylene glycol, polyethylene glycol and/or glycerol are added.

As shown in Table 1, hydrogel compositions in accordance with various embodiments of the present invention provide quite high swellability and weight gain ability, while still maintaining the hydrogel form.

TABLE 1

| | A | | B | | C | | D | | E | | F | | G | |
|---|---|---|---|---|---|---|---|---|---|---|---|---|---|---|
| | (g) | (%) | (g) | (%) | (g) | (%) | (g) | (%) | (g) | (%) | (g) | (%) | (g) | (%) |
| Solution A | 10.01 | 83.35 | 12.57 | 91.29 | 10.69 | 78.09 | | 0.00 | 10.40 | 78.79 | 10.40 | 80.43 | 10.18 | 74.74 |
| Propylene glycol | | 0.00 | | 0.00 | | 0.00 | | 0.00 | 0.80 | 6.06 | | 0.00 | | 0.00 |
| PEG | | 0.00 | | 0.00 | | 0.00 | | 0.00 | | 0.00 | 0.53 | 4.10 | | 0.00 |
| Glycerol | | 0.00 | | 0.00 | | 0.00 | | 0.00 | | 0.00 | | 0.00 | 1.44 | 10.57 |
| Prepolymer | 2.00 | 16.65 | 1.20 | 8.71 | 3.00 | 21.91 | 3.10 | 23.17 | 2.00 | 15.15 | 2.00 | 15.47 | 2.00 | 14.68 |
| Water | | 0.00 | | 0.00 | | 0.00 | 10.28 | 76.83 | | 0.00 | | 0.00 | | 0.00 |
| | 12.01 | 100.00 | 13.77 | 100.00 | 13.69 | 100.00 | 13.38 | 100.00 | 13.20 | 100.00 | 12.93 | 100.00 | 13.62 | 100.00 |

| | | | | | | |
|---|---|---|---|---|---|---|
| Weight (g) | | | | | | |
| Initial | 1.40 | 1.99 | 1.96 | 1.45 | 1.3 | 1.2 |
| 18 h | 5 | 6.57 | 2.65 | 4.28 | 4.15 | 3.73 |
| 42 h | 5.28 | 7.91 | 3.25 | 4.28 | 4.33 | 3.86 |
| Swelling % | | | | | | |
| Initial | 0.00 | 0.00 | 0.00 | 0.00 | 0.00 | 0.00 |
| 18 h | 257.14 | 230.15 | 35.20 | 195.17 | 219.23 | 210.83 |
| 42 h | 277.14 | 297.49 | 65.82 | 195.17 | 233.08 | 221.67 |

In further examples H-K, shown in Table 2, alternative embodiments of the present invention are prepared by preparing hydrogel compositions including the following ingredients:

TABLE 2

| Ingredient | H (%) | I (%) | J (%) | K (%) |
|---|---|---|---|---|
| Water | 36 | 36 | 32 | 32 |
| Propylene glycol | 10 | 17 | 10 | 15 |
| PEG-400 | 22 | 15 | 21 | 16 |
| β-hydroxypropyl- | 4 | 4 | 8 | 8 |
| cyclodextrin | | | | |
| Triacetin | 0 | 0 | 0 | 0 |
| JEFFAMINE ® | 14 | 14 | 14.5 | 14.5 |
| ED-600 | | | | |
| HYPOL ® | 14 | 14 | 14.5 | 14.5 |
| G-50 | | | | |
| Total | 100 | 100 | 100 | 100 |
| % Swelling | 369 | 312 | 449 | 438 |

When the hydrogel compositions H-K shown in Table 2 are exposed to water, they are able to absorb water and swell by the amounts shown in the bottom row of the Table 2.

### Personal Care Products

In one embodiment, the present invention further relates to a process for preparing a hydrogel-containing article such as a personal care product, comprising:

providing a cyclodextrin;

providing a polyurethane prepolymer;

combining the cyclodextrin with the polyurethane prepolymer;

allowing the polyurethane prepolymer to react with and crosslink the cyclodextrin; and

applying the combined cyclodextrin and polyurethane prepolymer to a substrate to form the hydrogel-containing personal care product.

In one embodiment, the step of combining is followed by the step of allowing the polyurethane prepolymer to react with and crosslink the polyurethane prepolymer to the substrate. In one embodiment, the step of combining is followed by the step of applying the combined cyclodextrin and polyurethane prepolymer to the substrate, which is followed by allowing the polyurethane prepolymer to react with and crosslink the cyclodextrin. Thus, the crosslinking reaction in the allowing step may take place before, during or after the applying step. In one embodiment, the crosslinking reaction in the allowing step begins as soon as the cyclodextrin and polyurethane prepolymer are combined and continues during and subsequent to the step of applying the combined cyclodextrin and polyurethane prepolymer to the substrate.

In one embodiment, the substrate comprises a backing layer or a release liner on at least a portion of which the hydrogel forms a layer. The backing layer and the release liner may be formed of any suitable material, depending primarily upon what type of personal care product is to be formed.

In one embodiment of the personal care product, the hydrogel is in the form of a patch, in which the hydrogel is located on a backing layer. The hydrogel composition may also have a release liner on the side thereof away from the backing layer, particularly when the hydrogel composition is adhesive. The backing layer may further comprise a pressure sensitive adhesive layer to enhance adhesion to the user's anatomy or to other parts of the personal care product.

The term “backing layer” refers to that component of an article such as a personal care product, for example, an infant diaper, sanitary napkin, adult incontinence garment or the like which is worn during normal use furthest from the user's body and which may serve to minimize or prevent the exudation of the absorbed liquid, or to protect the underlying elements of user's skin.

The backing layer can be any material convenient to the particular application. The backing layer can be made of any suitable natural or synthetic fiber or fabric, and can be woven or non-woven. Various materials can be used as the backing material. Specific examples include papers, non-woven fabrics, natural fiber (e.g., cotton) fabrics, synthetic resin fabrics, synthetic resin films, synthetic resin foams, mesh-form or network papers, woven fabrics, and knit fabrics. Surgical tapes, medical pressure-sensitive adhesive sheets, pressure-sensitive adhesive dressings, constructed with the above films, foams, non-woven fabrics, woven fabrics, or knits can also be used as a backing material. The backing layer can also be in the form of an impermeable or permeable foam made from natural materials or from synthetic materials such as polyolefin, polyester, polyurethane, and the like.

Examples of suitable backing materials include polyurethanes such as ESTANE® polyurethanes (B.F. Goodrich, Cleveland, Ohio) including, for example, ESTANE® 58237, ESTANE® 58245, and ESTANE® 58309. Other suitable backing materials include elastomeric polyester such as HYTREL® polyester elastomer (E.I. duPont deNemours & Co., Wilmington, Del.), blends of polyurethane and polyester, and polyvinyl chloride. Thermoplastic polyether-amide block copolymers such as PEBAX® 2533 and PEBAX® 3533 (available from Atochem Co.); and polyether-ester block copolymers may also be used.

In one embodiment, the backing layer has a thickness of from about 15 to about 100 micrometers or more, in one embodiment from about 20 to about 80 micrometers and in another embodiment, from about 20 to about 50 micrometers.

In one embodiment, the backing layer is a transparent, conformable, moisture vapor permeable film. In one embodiment, the backing layer is also elastomeric. In one embodiment, the backing film is impermeable to liquid water and has a moisture vapor transmission rate (MVTR) of at least 300 g per 24 hr at 37° C. and 80% relative humidity.

In an embodiment in which the backing extends beyond the area of the hydrogel composition, the backing may include an adhesive that may also serve as a skin contact adhesive around the border of the backing layer.

In one embodiment, the personal care product may include a liquid permeable skin or wound contacting layer and an outer, liquid-impervious backing layer, in which the hydrogel composition is between these two layers.

In one embodiment, the backing layer may extend beyond at least one edge of the hydrogel composition to provide an adhesive coated margin adjacent to the hydrogel composition for adhering the product to a surface, such as to the skin of a patient adjacent to the wound being treated. In one embodiment, an adhesive coated margin may extend around all sides of the product. In another embodiment, there is no adhesive-coated margin.

The release liner can be any suitable material known to the art or to the literature and generally is a plastic which, in one embodiment, contains a release agent thereon such as a silicone. The release liner can be a plastic such as a polyolefin, for example polyethylene or polypropylene, or it can be polyvinylchloride, nylon, and the like. In one embodiment, it can contain a release liner thereon such as a thin layer of silicone. In such an embodiment, the product can be applied to a substrate such as human skin simply by removing the release liner and applying thereto the hydrogel-containing the backing.

In one embodiment, the personal care product comprises one or more of a bandage, a wound dressing, a wipe, a diaper, a diaper pant, a training pant, an absorbent underpant, a protective swimming undergarment, an incontinence garment, a panty shield or liner, a feminine hygiene product or a perspiration shield. Other personal care products known in the art may also be included within the scope of the present invention. In one embodiment, the personal care product may be any such product that can benefit from the presence of a hydrogel somewhere in its structure.

In one embodiment, the hydrogel composition used in the personal care product further includes a quantity of non-modified cyclodextrin crosslinked with the polyurethane prepolymer or simply as a component of the hydrogel without being crosslinked. The non-modified cyclodextrin may be unbonded or may be singly bonded to the hydrogel structure.

In one embodiment, at least a portion of the non-modified cyclodextrin is complexed. That is, in one embodiment, at least a portion of the non-modified cyclodextrin includes another material, such as a pharmaceutical, a perfume or some other material in or partially the cavity of the cyclodextrin molecule.

In one embodiment, at least a portion of the modified cyclodextrin is complexed. That is, in one embodiment, at least a portion of the modified cyclodextrin includes another material, such as a pharmaceutical, a perfume or some other material in or partially the cavity of the cyclodextrin molecule.

In one embodiment, the personal care product may be made by any of the various process alternatives described herein.

In one embodiment, the present invention relates to a personal care product including a hydrogel composition including a modified cyclodextrin crosslinked with a polyurethane prepolymer, in which the hydrogel is applied to a substrate, wherein a ratio of the modified cyclodextrin to the polyurethane prepolymer is selected to result in formation of the hydrogel.

While the invention has been explained in relation to various of its embodiments, it is to be understood that various modifications thereof will become apparent to those skilled in the art upon reading the specification. Therefore, it is to be understood that the invention disclosed herein is intended to cover modifications as fall within the scope of the claims.

1. A hydrogel composition comprising a modified cyclodextrin crosslinked with a polyurethane prepolymer, wherein at least one cyclodextrin hydroxyl group is modified.

2. The hydrogel composition of claim 1 wherein a ratio of the modified cyclodextrin to the polyurethane prepolymer is selected to result in formation of the hydrogel.

3. The hydrogel composition of claim 1 wherein the modified cyclodextrin is a cyclodextrin modified by being bonded to a moiety comprising at least one isocyanate-reactive group.

4. The hydrogel composition of claim 3 wherein the at least one isocyanate-reactive group comprises a hydroxyalkyl group, an aminoalkyl group, a carboxyl group, a sulfhydryl group, an epoxy group, or a combination of any two or more thereof.

5. The hydrogel composition of claim 1 wherein the polyurethane prepolymer comprises a reactive isocyanate moiety.

6. The hydrogel composition of claim 5 wherein the reactive isocyanate moiety comprises an aliphatic, cycloaliphatic, arylaliphatic, heterocyclic or aromatic polyisocyanate or a mixture thereof.

7. The hydrogel composition of claim 5 wherein the polyurethane prepolymer has an average isocyanate functionality of about 2 or greater.

8. The hydrogel composition of claim 1 wherein the modified cyclodextrin crosslinked by a polyurethane prepolymer comprises a reaction product of a reactive isocyanate moiety reacted with at least one isocyanate-reactive group on the cyclodextrin.

9. The hydrogel composition of claim 8 wherein the at least one isocyanate-reactive group is a primary hydroxyl group of the cyclodextrin, a secondary hydroxyl group of the cyclodextrin, an active hydrogen on a modifying group attached to the cyclodextrin, or a combination of any two or more thereof.

10. The hydrogel composition of claim 9 wherein at least a portion of the isocyanate-reactive group is the active hydrogen on a modifying group attached to the cyclodextrin.

11. The hydrogel composition of claim 1 wherein the hydrogel further comprises an alkylene glycol, a polyalkylene glycol, glycerol or a combination of any two or more thereof.

12. The hydrogel composition of claim 11 wherein a portion of the alkylene glycol, the polyalkylene glycol, the glycerol or the combination of any two or more thereof is chemically bonded to the polyurethane prepolymer.

13. The hydrogel composition of claim 1 further comprising non-crosslinked modified and/or non-crosslinked non-modified cyclodextrin.

14. The hydrogel composition of claim 13 wherein the non-crosslinked modified cyclodextrin comprises free modified and/or non-modified cyclodextrin, modified and/or non-modified cyclodextrin singly bonded to the polyurethane prepolymer or a mixture of any two or more thereof.

15. The hydrogel composition of claim 1 further comprising non-modified cyclodextrin crosslinked with the polyurethane prepolymer, wherein at least a portion of the non-modified cyclodextrin is optionally complexed.

16. The hydrogel composition of claim 1 wherein at least a portion of the modified cyclodextrin is complexed.

17. The hydrogel composition of claim 1 wherein the hydrogel has an original volume and upon absorption of water is capable of swelling to a volume at least about 100% greater than its original volume.

18. The hydrogel composition of claim 1 wherein the hydrogel has an original weight and upon absorption of water is capable of increasing its weight to a weight at least about 100% greater than its original weight.

19. A personal care product comprising the hydrogel composition of claim 1.

20. A process for preparing a hydrogel composition, comprising:
providing a modified cyclodextrin, wherein at least one cyclodextrin hydroxyl group is modified;
providing a polyurethane prepolymer; and
combining the modified cyclodextrin with the polyurethane prepolymer; and
allowing the polyurethane prepolymer to react with and crosslink the cyclodextrin to form the hydrogel composition.

21. The process of claim 20 further comprising providing an alkylene glycol, a polyalkylene glycol, glycerol or a combination of any two or more thereof and combining the alkylene glycol, the polyalkylene glycol, the glycerol or the combination of any two or more thereof with the modified cyclodextrin and the polyurethane prepolymer in the combining or premixing the alkylene glycol, the polyalkylene glycol, the glycerol or the combination of any two or more thereof with the modified cyclodextrin prior to the combining.

22. The process of claim 20 further comprising combining a non-modified cyclodextrin with the modified cyclodextrin and the polyurethane prepolymer in the combining or premixing the non-modified cyclodextrin with the modified cyclodextrin prior to the combining.

23. The process of claim 20 wherein a ratio of the modified cyclodextrin and the polyurethane prepolymer is selected to result in formation of the hydrogel.

24. The process of claim 20 wherein the modified cyclodextrin is modified by being bonded to a moiety comprising at least one isocyanate-reactive group.

25. The process of claim 24 wherein the at least one isocyanate-reactive group comprises a hydroxyalkyl group, an aminoalkyl group, a carboxyl group, a sulfhydryl group, an epoxy group, or a combination of any two or more thereof.

26. The process of claim 20 wherein the polyurethane prepolymer comprises a reactive isocyanate moiety.

27. The process of claim 26 wherein the reactive isocyanate moiety comprises an aliphatic, cycloaliphatic, arylaliphatic, heterocyclic or aromatic polyisocyanate or a mixture thereof.

28. The process of claim 26 wherein the polyurethane prepolymer has an average isocyanate functionality of about 2 or greater.

29. The process of claim 20 wherein the modified cyclodextrin is crosslinked by the reaction of a reactive isocyanate moiety in the polyurethane prepolymer with at least one isocyanate-reactive group on the cyclodextrin.

30. The process of claim 29 wherein the at least one isocyanate-reactive group is a primary hydroxyl group of the cyclodextrin, a secondary hydroxyl group of the cyclodextrin, an active hydrogen on a modifying group attached to the cyclodextrin, or a combination of any two or more thereof.

31. The process of claim 30 wherein at least a portion of the isocyanate-reactive group is the active hydrogen on a modifying group attached to the cyclodextrin.

32. The process of claim 20 further comprising an alkylene glycol, a polyalkylene glycol, glycerol or a combination of any two or more thereof.

33. The process of claim 32 wherein a portion of the alkylene glycol, the polyalkylene glycol, the glycerol or a combination of any two or more thereof is chemically bonded to the polyurethane prepolymer.

34. The process of claim 20 wherein the hydrogel further comprises non-crosslinked modified and/or non-crosslinked non-modified cyclodextrin.

35. The process of claim 20 wherein the non-crosslinked modified cyclodextrin comprises free modified and/or non-modified cyclodextrin, modified and/or non-modified cyclodextrin singly bonded to the polyurethane prepolymer or a mixture of any two or more thereof.

36. The process of claim 20 further comprising non-modified cyclodextrin crosslinked with the polyurethane prepolymer, wherein at least a portion of the non-modified cyclodextrin is optionally complexed.

37. The process of claim 20 wherein at least a portion of the modified cyclodextrin is complexed.

38. The process of claim 20 wherein the hydrogel has an original volume and upon absorption of water is capable of swelling to a volume at least about 100% greater than its original volume.

39. The process of claim 20 wherein the hydrogel has an original weight and upon absorption of water is capable of increasing its weight to a weight at least about 100% greater than its original weight.

40. The process of claim 20 wherein the combining comprises first applying one of the modified cyclodextrin or the polyurethane prepolymer to a substrate and second applying another of the modified cyclodextrin or polyurethane prepolymer to the substrate, followed by the allowing.

41. A personal care product including a hydrogel composition made by the process of claim 20.

42. A process for preparing a hydrogel-containing personal care product, comprising:
providing a modified cyclodextrin, wherein at least one cyclodextrin hydroxyl group is modified;
providing a polyurethane prepolymer;
combining the modified cyclodextrin with the polyurethane prepolymer;
allowing the polyurethane prepolymer to react with and crosslink the cyclodextrin; and
applying the combined cyclodextrin and polyurethane prepolymer to a substrate to form the hydrogel-containing personal care product.

43. The process of claim 42 wherein the substrate comprises a backing layer on at least a portion of which the hydrogel forms a layer.

44. The process of claim 42 wherein the personal care product comprises one or more of a bandage, a wound dressing, a wipe, a diaper, a diaper pant, a training pant, an absorbent underpants a protective swimming undergarment, an incontinence garment, a panty shield or liner, a feminine hygiene product or a perspiration shield.

45. The process of claim 42 further comprising providing an alkylene glycol, a polyalkylene glycol, glycerol or a combination of any two or more thereof and combining the alkylene glycol, the polyalkylene glycol, the glycerol or the combination of any two or more thereof with the modified cyclodextrin and the polyurethane prepolymer in the combining or premixing the alkylene glycol, the polyalkylene glycol, the glycerol or the combination of any two or more thereof with the modified cyclodextrin prior to the combining.

46. The process of claim 42 further comprising combining a non-modified cyclodextrin with the modified cyclodextrin and the polyurethane prepolymer in the combining or premixing the non-modified cyclodextrin with the modified cyclodextrin prior to the combining.

47. The process of claim 42 wherein a ratio of the modified cyclodextrin and the polyurethane prepolymer is selected to result in formation of the hydrogel.

48. The process of claim 42 wherein the modified cyclodextrin is modified by being bonded to a moiety comprising at least one isocyanate-reactive group.

49. The process of claim 48 wherein the at least one isocyanate-reactive group comprises a hydroxyalkyl group, an aminoalkyl group, a carboxyl group, a sulfhydryl group, an epoxy group, or a combination of any two or more thereof.

50. The process of claim 42 wherein the polyurethane prepolymer comprises a reactive isocyanate moiety.

51. The process of claim 50 wherein the reactive isocyanate moiety comprises an aliphatic, cycloaliphatic, arylaliphatic, heterocyclic or aromatic polyisocyanate or a mixture thereof.

52. The process of claim 50 wherein the polyurethane prepolymer has an average isocyanate functionality of about 2 or greater.

53. The process of claim 42 wherein the modified cyclodextrin is crosslinked by the reaction of a reactive isocyanate moiety in the polyurethane prepolymer with at least one isocyanate-reactive group on the cyclodextrin.

54. The process of claim 42 wherein the at least one isocyanate-reactive group is a primary hydroxyl group of the cyclodextrin, a secondary hydroxyl group of the cyclodextrin, an active hydrogen on a modifying group attached to the cyclodextrin, or a combination of any two or more thereof.

55. The process of claim 54 wherein at least a portion of the isocyanate-reactive group is the active hydrogen on a modifying group attached to the cyclodextrin.

56. The process of claim 42 further comprising an alkylene glycol, a polyalkylene glycol, glycerol or a combination of any two or more thereof.

57. The process of claim 56 wherein a portion of the alkylene glycol, the polyalkylene glycol, the glycerol or a combination of any two or more thereof is chemically bonded to the polyurethane prepolymer.

58. The process of claim 42 wherein the hydrogel further comprises non-crosslinked modified and/or non-crosslinked non-modified cyclodextrin.

59. The process of claim 42 wherein the non-crosslinked modified cyclodextrin comprises free modified and/or non-modified cyclodextrin, modified and/or non-modified cyclodextrin singly bonded to the polyurethane prepolymer or a mixture of any two or more thereof.

60. The process of claim 42 further comprising non-modified cyclodextrin crosslinked with the polyurethane prepolymer.

61. The process of claim 60 wherein at least a portion of the non-modified cyclodextrin is complexed.

62. The process of claim 42 wherein at least a portion of the modified cyclodextrin is complexed.

63. The process of claim 42 wherein the applying the combined cyclodextrin and polyurethane prepolymer to a substrate is carried out prior to or during the allowing.

64. The process of claim 42 wherein the applying the combined cyclodextrin and polyurethane prepolymer to a substrate is carried out subsequent to the allowing.

65. The process of claim 42 wherein the combining comprises first applying one of the modified cyclodextrin or the polyurethane prepolymer to a substrate and second applying another of the modified cyclodextrin or polyurethane prepolymer to the substrate, followed by the allowing.

66. A personal care product made by the process of claim 42.

67. A personal care product comprising a hydrogel composition applied to a substrate, wherein the hydrogel composition comprises a modified cyclodextrin crosslinked with a polyurethane prepolymer, wherein a ratio of the modified cyclodextrin to the polyurethane prepolymer is selected to result in formation of the hydrogel, wherein at least one cyclodextrin hydroxyl group is modified.
